(19) United States
(12) Patent Application Publication
(10) Pub. No.: US 2006/0220897 A1
(43) Pub. Date: Oct. 5, 2006

(54) Notebook with power indication

(75) Inventor: Ning-Ning Cheng, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/268,563

(22) Filed: Nov. 8, 2005

(30) Foreign Application Priority Data
Mar. 18, 2005 (TW) 94108502

(51) Int. Cl. G08B 5/00; G08B 21/00

(52) U.S. Cl. 340/815.4; 340/636.1

(57) ABSTRACT

The present invention relates to a notebook with power indication. The notebook includes a main unit, a battery, a power indicator, and a sensor. The battery provides power for the main unit. The power indicator is electrically connected to the battery for proving the power indication of the battery. The sensor is electrically connected to the power indicator for activating the power indicator while sensing a user.

### RELATED APPLICATIONS

The present application is based on, and claims priority from, Taiwan Application Serial Number 94108502, filed Mar. 18, 2005, the disclosure of which is hereby incorporated by reference herein in its entirety.

### BACKGROUND

1. Field of Invention

The present invention relates to a notebook. More particularly, the present invention relates to a notebook with power indication.

2. Description of Related Art

The notebook has become more prevalent recently. One advantage of the notebook is that it can be powered by a battery, which enables the user to use the notebook in a circumstance without the electrical outlet. Therefore, the remaining power in the battery becomes critical information while the notebook is powered by the battery. The user demands to know the power status in order to back up important data before the power runs out.

Currently, the power indication is incorporated into the operation system. For example, in the Windows® operation system, the power status is indicated by a power icon in the tool bar. By clicking the power icon, the user can obtain the updated power status in the battery.

However, the primary drawback of this type of power indication is that the notebook has to be turned on before the user can check the power status. This brings significant inconvenience particularly if the notebook is in power-off status. The user therefore needs to spend a lot of time turning on the notebook and loading the operation system just in order to check the power status.

Therefore, there is a need for an improved power indication strategy for the notebook that the user can check the power status whether the notebook is powered on or powered off.

### SUMMARY

It is therefore an objective of the present invention to provide a notebook with a power indicator that can provide an instant power status.

It is another objective of the present invention to provide a notebook with a power indicator that can sense the user for displaying an instant power status.

In accordance with the foregoing and other objectives of the present invention, a notebook with power indication is provided. An exemplary embodiment of the notebook includes a main unit, a battery, and a power indicator. The battery provides power for the main unit. The power indicator is electrically connected to the battery for displaying the power status of the battery.

In accordance with another objective of the present invention, a notebook with power indication is provided. An exemplary embodiment of the notebook includes a main unit, a battery, a power indicator, and a sensor. The battery provides the power for the main unit. The power indicator is electrically connected to the battery for displaying the power status of the battery. The sensor is connected to the power indicator for activating the power indicator while sensing the using message. For corresponding to different sensors, the using message could be a touch, the infrared rays, user's temperature, and the user's voice.

The notebook according to the present invention can provide power indication whether the notebook is powered on or powered off. Besides, the notebook according to the present invention provides a sensor that can activate the power indicator while sensing the user. The user therefore does not have to turn on the notebook and load the operating system and can retrieve the instant power status.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1A is a perspective diagram illustrating the notebook according to one preferred embodiment of the present invention;

FIG. 1B to FIG. 1D are diagrams illustrating the power indicator in different power statuses according to one preferred embodiment of the present invention;

FIG. 2A is a perspective diagram illustrating the notebook according to another preferred embodiment of the present invention; and

FIG. 2B to FIG. 2D are diagrams illustrating the power indicator in different power statuses according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The notebook according to the present invention is equipped with a power indicator electrically connected to the battery for providing the power status whether the notebook is powered on or not.

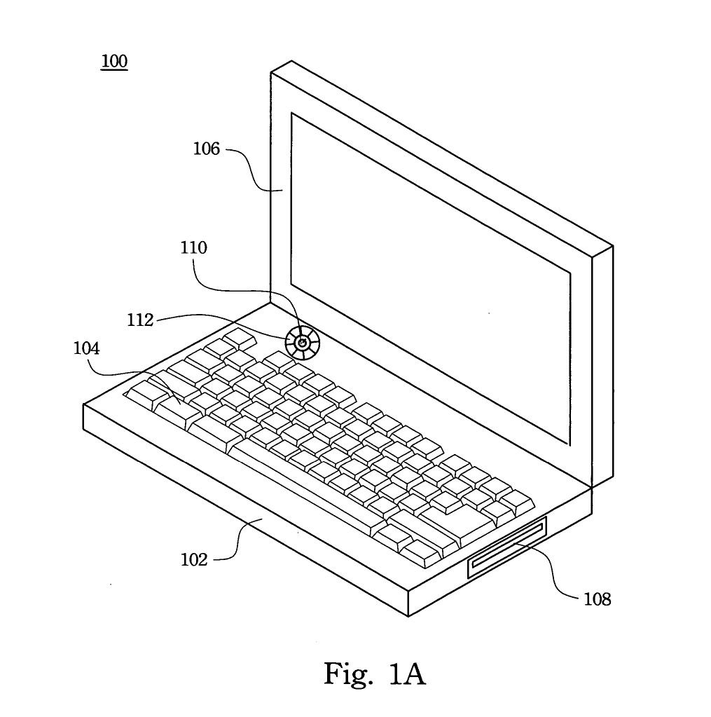

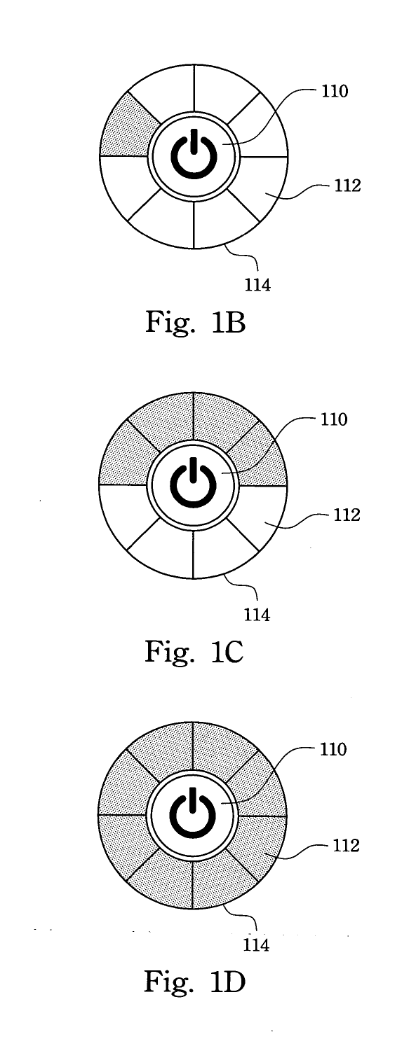

FIG. 1A to FIG. 1D illustrate the notebook with power indication according to one preferred embodiment of the present invention. As shown in the FIG. 1A, the notebook 100 includes a main unit 102, a keyboard 104, a monitor 106, a battery 108, a power button 110, and a power indicator 112.

The notebook 100 can be powered by various power sources, such as electrical outlet or the battery 108. The power indicator 112 is electrically connected to the batter 108 for indicating the power status. The configuration of the power indicator 112 is circular and surrounds the power button 110. The power indicator 112 is configured to display the power status of the batter 108 while the battery 108 is inserted into the main unit 102.

FIG. 1B to FIG. 1D are diagrams illustrating the power indicator 112 in different power statuses. The power indicator 112, for example, can be a LED (Light Emitting Diode), and is divided into several displaying blocks 114. The power status of the battery 108 can be indicated by the number or the color of the displaying block 114 displayed. For example, as shown in the FIG. 1B, only one displaying block 114 is displayed. This represents that the battery 108 is in low power status, and the user may need to recharge the battery 108 immediately. While in the FIG. 1C, four displaying blocks 114 are displayed, indicating that half power is remained in the battery 108. While the battery 108 is fully charged, all displaying blocks 114 are displayed, as shown in the FIG. 1D.

Besides, various colors can also be employed and incorporated into the displaying blocks 114 for enhancing the displaying effect. For example, in the low power status shown in the FIG. 1B, the displaying block 114 can be displayed in red to alert the user. Meanwhile, in the power status shown in the FIG. 1C, the displaying blocks 140 can be displayed in yellow, representing half power is remained in the battery 108. Further, the displaying blocks 140 can be displayed in green in the full power status shown in the FIG. 1C.

As described above, the power indicator can be configured to display the power status while the battery 108 is inserted into the main unit 102. Besides, for further preserving the power in the battery 108, a sensor can be implemented to activate the power indicator 112 only when the sensor senses the user. For example, the sensor can be incorporated into the power button 110 or the power indicator 112, and is electrically connected to the power indicator 112. While the user gently touches the power button 110 or the power indicator 112, the sensor can sense the user and activate the power indicator 112 for indicating the current power status.

The sensor can be a touch sensor that senses the user by touching. The sensor can also be an IR sensor, which senses the user by infrared rays (IR). Alternatively, the sensor can also be a heat sensor or a voice sensor that either senses the user's temperature or voice.

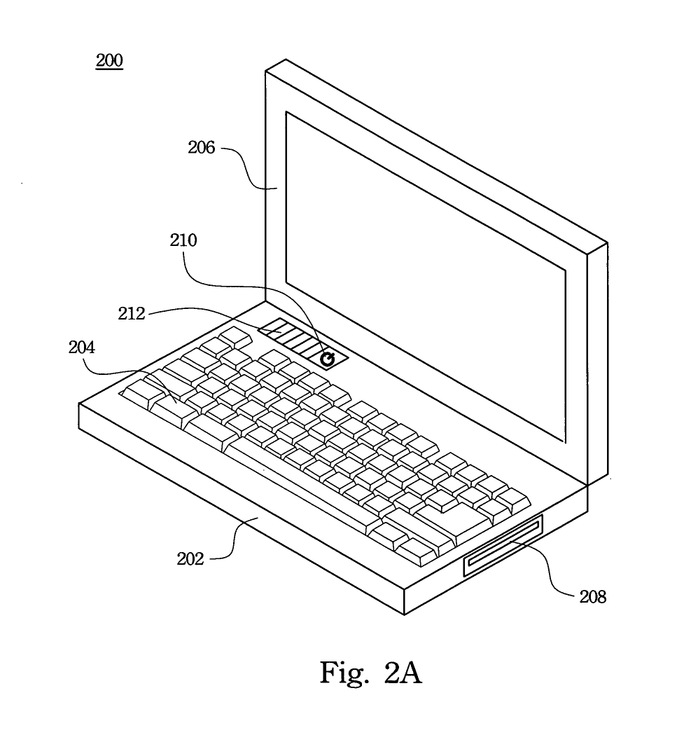

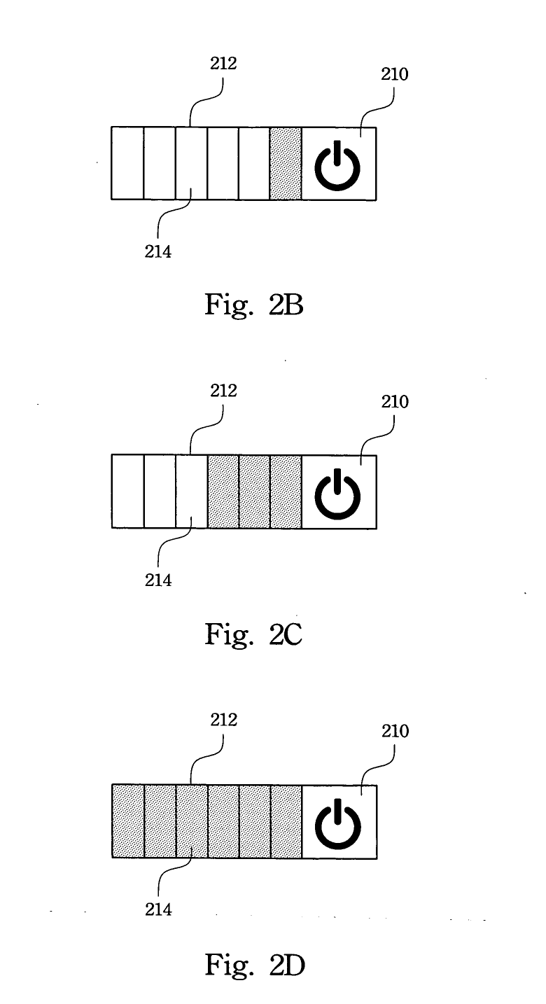

FIG. 2A to FIG. 2D illustrate the notebook with power indication according to another preferred embodiment of the present invention. As shown in the FIG. 2A, the notebook 200 includes a main unit 202, a keyboard 204, a monitor 206, a battery 208, a power button 210, and a power indicator 212.

Various power sources, such as electrical outlet or the battery 208 can power the notebook 200. The power indicator 212 is electrically connected to the batter 208 for indicating the power status. The configuration of the power indicator 212 is rectangular and next to the power button 210. The power indicator 212 is configured to display the power status of the batter 208 while the battery 208 is inserted into the main unit 202.

FIG. 2B to FIG. 2D are diagrams illustrating the power indicator 212 in different power statuses. The power indicator 212, for example, can be a LED, and is divided into several displaying blocks 214. The number can indicate the power status or the color of the displaying block 214 displayed. For example, as shown in the FIG. 2B, only one displaying block 214 is displayed. This represents that the battery 208 is in low power status, and the user may need to recharge the battery 208 immediately. While in the FIG. 2C, three displaying blocks 214 are displayed, indicating that half power is remained in the battery 208. While the battery 208 is fully charged, all displaying blocks 214 are displayed, as shown in the FIG. 2D.

Besides, various colors can also be employed and incorporated into the displaying blocks 214 for enhancing the displaying effect. For example, in the low power status shown in the FIG. 2B, the displaying block 214 can be displayed in red to alert the user. Meanwhile, in the power status shown in the FIG. 2C, the displaying blocks 214 can be displayed in yellow, representing half power is remained in the battery 208. Further, the displaying blocks 214 can be displayed in green in the full power status shown in the FIG. 2C.

As described above, the power indicator can be configured to display the power status while the battery 208 is inserted into the main unit 202. Besides, for further preserving the power in the battery 208, a sensor can be implemented to activate the power indicator 212 only when the sensor senses the user. For example, the sensor can be incorporated into the power button 210 or the power indicator 212, and is electrically connected to the power indicator 212. While the user gently touches the power button 210 or the power indicator 212, the sensor can sense the user and activate the power indicator 212 for indicating the current power status.

The sensor can be a touch sensor that senses the user by touching. The sensor can also be an IR sensor, which senses the user by IR. Alternatively, the sensor can also be a heat sensor or a voice sensor that either senses the user's temperature or voice.

The notebook according to the present invention can provide power indication whether the notebook is powered on or powered off. Besides, the notebook according to the present invention provides a sensor that can activate the power indicator while sensing the user. The user therefore does not have to turn on the notebook and load the operating system and can retrieve the instant power status.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A notebook with power indication, the notebook comprising:
a main unit;
a battery for providing power to the main unit; and
a power indicator electrically connected to the battery for displaying a power status of the battery.

2. The notebook of claim 1, wherein the power indicator is a LED (Light Emitting Diode).

3. The notebook of claim 1, wherein the power indicator surrounds a power button of the main unit.

4. The notebook of claim 1, wherein the power indicator is circular.

5. The notebook of claim 1, wherein the power indicator is rectangular.

6. The notebook of claim 1, further comprising a sensor electrically connected to the power indicator for activating the power indicator while sensing a using message.

7. The notebook of claim 6, wherein the sensor is a touch sensor and the using message is a touch.

8. The notebook of claim 6, wherein the sensor is an IR sensor and the using message is the infrared rays (IR).

9. The notebook of claim 6, wherein the sensor is a heat sensor and the using message is the user's temperature.

10. The notebook of claim 6, wherein the sensor is a voice sensor and the using message is the user's voice.

11. The notebook of claim 6, wherein the sensor is incorporated into a power button of the main unit.

12. The notebook of claim 6, wherein the sensor is incorporated into the power indicator.

13. A notebook with power indication, the notebook comprising:
a main unit;
a battery for providing power to the main unit;
a power indicator electrically connected to the battery for displaying a power status of the battery; and
a sensor electrically connected to the power indicator for activating the power indicator while sensing a using message.

14. The notebook of claim 13, wherein the power indicator is a LED (Light Emitting Diode).

15. The notebook of claim 13, wherein the power indicator surrounds a power button of the main unit.

16. The notebook of claim 13, wherein the power indicator is circular.

17. The notebook of claim 13, wherein the power indicator is rectangular.

18. The notebook of claim 13, wherein the sensor is a touch sensor and the using message is a touch.

19. The notebook of claim 13, wherein the sensor is an IR sensor and the using message is the infrared rays (IR).

20. The notebook of claim 13, wherein the sensor is a heat sensor and the using message is the user's temperature.

21. The notebook of claim 13, wherein the sensor is a voice sensor and the using message is the user's voice.

22. The notebook of claim 13, wherein the sensor is incorporated into a power button of the main unit.

23. The notebook of claim 13, wherein the sensor is incorporated into the power indicator.
